(19) United States
(12) Patent Application Publication
(10) Pub. No.: US 2026/0021743 A1
(43) Pub. Date: Jan. 22, 2026

(54) METHOD FOR OPERATING A DRIVE DEVICE FOR A MOTOR VEHICLE, CORRESPONDING DRIVE DEVICE FOR A MOTOR VEHICLE AND COMPUTER PROGRAM PRODUCT

(71) Applicant: AUDI AG, lngolstadt (DE)

(72) Inventor: Uwe FELDMANN, Nassenfels (DE)

(73) Assignee: AUDI AG, lngolstadt (DE)

(21) Appl. No.: 19/269,336

(22) Filed: Jul. 15, 2025

(30) Foreign Application Priority Data
Jul. 19, 2024 (DE) 102024120579.2

(51) Int. Cl. B60L 58/18; B60L 15/00; B60L 50/60; B60L 58/12; H01M 10/42; H01M 50/204; H01M 50/249; H01M 50/509

(52) U.S. Cl. CPC B60L 58/18; B60L 15/007; B60L 50/60; B60L 58/12; H01M 10/425; H01M 50/204; H01M 50/249; H01M 50/509; H01M 2220/20

(57) ABSTRACT

A method for operating a drive device for a motor vehicle, includes a traction battery having a plurality of cell modules and a drive unit which is designed as an electric traction machine and is electrically connected via an inverter to electrical connections of the traction battery. The cell modules can be electrically connected in different ways between the connections. The cell modules are divided up into battery modules which in each case contain the same number of electrically parallel-connected cell modules and are electrically connected in series between the connections. A number of the battery modules is adapted during operation of the drive device in such a way that an electrical voltage applied to the connections corresponds to at least an operating voltage of the traction machine.

### FIELD

The invention relates to a method for operating a drive device for a motor vehicle, wherein the drive device has a traction battery having a plurality of cell modules and a drive unit which is designed as an electric traction machine and is electrically connected to electrical connections of the traction battery via an inverter, wherein the cell modules can be electrically connected in different ways between the connections. The invention further relates to a drive device for a motor vehicle and a computer program product.

### BACKGROUND

In the prior art document DE 10 2019 212 860 A1 is known, for example. This document describes a battery system for a motor vehicle, wherein a respective switching unit is provided for each battery component of the battery system, said switching unit being designed to define one of a plurality of possible mutual connections of the battery components to one another depending on the respective switching state of the switching unit, wherein a processor device is designed to switch the respective switching state of the switching unit of at least one of the battery components to a predetermined target state thereof in a shift register for this respective battery component, by means of a respective enable signal, to set a predetermined enable level at each flip-flop output of a shift register associated with this battery component, and to set a predetermined disable level at each remaining flip-flop output and to generate the select signal for the target state in at least one common select line.

Furthermore, publication DE 10 2021 119 607 A1 discloses an energy storage device having at least one connection for connecting the energy storage device to an electrical network, and battery cells for storing energy and a cell contacting device which is configured to connect the battery cells to the at least one connection. According to the invention, the cell contacting device is configured as a multi-layer cell contacting device, wherein the multi-layer cell contacting device comprises at least one layer system for a respective voltage layer, wherein the at least one layer system comprises at least one respective conductor layer in order to connect the battery cells to the at least one connection of the energy storage device, and the multi-layer cell contacting device comprises a switching device which comprises a control unit and a plurality of controllable switching units, wherein the control unit is configured to connect the battery cells to the respective layer system according to one of at least two predetermined connection configurations of the switching units in order to provide the respective voltage layer in the at least one layer system.

### SUMMARY

It is the object of the invention to propose a method for operating a drive device for a motor vehicle that offers advantages over known methods, particularly that enables the provision of an as high as possible continuous drive power of the drive device.

This is achieved according to the invention with a method for operating a drive device for a motor vehicle. In this case, it is provided that the cell modules are divided up into battery modules which each contain the same number of electrically parallel-connected cell modules and are electrically connected in series between the connections, wherein a number of the battery modules is adapted during operation of the drive device in such a way that an electrical voltage applied to the connections corresponds to at least one operating voltage of the traction machine.

It is pointed out that the exemplary embodiments explained in the description are not limiting; rather, any variations of the features disclosed in the description, the claims and the FIGURES can be implemented.

The method is used to operate the drive device. The drive device is provided and designed to drive the motor vehicle and thus to provide a drive torque that is provided for driving the motor vehicle. The drive device has the drive unit to provide the drive torque, which is provided as an electric traction machine. The drive device is preferably part of the motor vehicle, but can of course also be present separately from it, in particular until the drive device is fitted on or in the motor vehicle.

The electric traction machine is electrically connected to the traction battery, namely via the inverter. The traction machine is operated at least temporarily with electrical energy which is taken from the traction battery. Conversely, it can be provided to store electrical energy at least temporarily in the traction battery, which is provided using the electrical traction machine. The inverter is used for converting the direct current provided by the traction battery into alternating current for the traction machine or, conversely, for converting alternating current provided by means of the traction machine into direct current, which is supplied to the traction battery. The inverter is preferably designed as a pulse inverter.

The traction battery has a plurality of cell modules which are electrically connected between the electrical connections of the traction battery. The cell modules are to be understood as meaning elements of the traction battery which each have at least one battery cell of the traction battery. Each of the cell modules thus has at least one battery cell of a plurality of battery cells forming the traction battery. Each of the cell modules preferably has a plurality of battery cells, in particular each of the cell modules has the same number of battery cells. For example, the battery cells of each of the cell modules are electrically connected in series with one another. Each of the cell modules preferably comprises at least 10, at least 30 or at least 50 battery cells, in particular battery cells connected in series.

The cell modules can be electrically connected in different ways between the connections of the traction battery. It can be provided, for example, that one part of the cell modules is present electrically in series and another part is present electrically in parallel between the connections. Different electrical voltages can be provided at the connections by the different interconnection of the cell modules between the connections. In a series connection of the cell modules, a higher voltage is achieved than in a parallel connection.

The drive power of the traction machine depends significantly on the electric voltage of the electric current which the traction battery provides at the electric connections. The voltage can also be referred to as battery voltage. The battery voltage in turn depends on the voltages of the individual cell modules or of the individual battery cells. Since the voltages of the cell modules and correspondingly the battery voltage change with the charge level of the traction battery, the available drive power which is available for driving the motor vehicle by means of the traction machine also changes. In particular, the drive power decreases markedly as the charge level of the traction battery decreases.

Usually, the cell modules are electrically connected between the connections in such a way that the battery voltage corresponds to the nominal voltage of the traction machine when the traction battery is fully charged, i.e. a charge level of approximately or exactly 100%. Based on the nominal power of the traction machine available at the nominal voltage, its drive power decreases with decreasing charging level, for example to a maximum of 50%, a maximum of 40% or a maximum of 30% of the nominal power. This is perceived as disturbing by a user of the motor vehicle. For this reason, it is provided according to the invention that the cell modules are divided into battery modules. Each of the cell modules is thus assigned to one of the battery modules, so that each of the battery modules ultimately contains at least one of the cell modules. The use of the term battery modules in the plural does not mean quantification of the battery modules, but rather any desired number of cell modules can be present, i.e., for example, a single cell module or a plurality of cell modules. The term battery modules is thus used as a representative for at least one battery module, preferably a plurality of battery modules.

The cell modules are divided into the battery modules in such a way that each of the battery modules contains the same number of cell modules. The cell modules of each battery module are electrically connected in parallel. The battery modules, on the other hand, are electrically connected in series between the connections, so that the battery voltage corresponds to the sum of the individual voltages of the battery modules. The division of the cell modules into the battery modules and a corresponding connection of the cell modules between the connections takes place during the operation of the drive device. It is therefore provided that the cell modules are electrically connected to one another in different ways between the connections during the operation of the drive device, so that a first connection and a second connection of the cell modules are produced at times.

The cell modules are divided up between the battery modules and the corresponding interconnection of the cell modules in the battery modules and the battery modules is produced with one another in such a way that an electrical voltage is produced at the connections which corresponds at least to the operating voltage of the traction machine, that is to say, for example, exactly corresponds to the operating voltage or is greater than this. The operating voltage of the traction machine is to be understood as an electrical voltage which is currently used or is to be used for operating the traction machine. For example, the operating voltage is predetermined by a control device of the drive device.

Particularly preferably, the cell modules are divided up between the battery modules and electrically connected to one another in such a way that the battery voltage corresponds at least to the nominal voltage of the traction machine, in particular independently of the charge level of the traction battery. This means that during the operation of the drive device, the cell modules are divided between the battery modules as a function of the charge level, namely in such a way that the resulting voltage at the connections corresponds at least to the nominal voltage of the traction machine.

Before dividing the cell modules into the battery modules, the number of battery modules is determined. The number of battery modules is selected in such a way that the desired voltage is achieved at the connections, thus for example the voltage corresponds at least to the operating voltage of the traction machine or at least to the nominal voltage of the traction machine. With the described procedure, it is ensured, at least partially independently of the state of charge of the traction battery, that a high drive power can be provided using the traction machine.

According to a further development of the invention, the number of battery modules is selected such that the electrical voltage applied to the connections lies in a voltage range which contains the operating voltage, the voltage range being limited by a first threshold value in the direction of lower voltages and by a second threshold value in the direction of higher voltages. The voltage range encompasses the operating voltage of the traction machine and is limited on the one hand by the first threshold value and on the other hand by the second threshold value. For example, the operating voltage is centrally in the voltage range, i.e. centrally between the first threshold value and the second threshold value. Instead of the operating voltage, the voltage range can also encompass the nominal voltage of the traction machine.

The number of battery modules into which the cell modules are divided is determined in such a way that the electrical voltage provided at the connections, i.e. the battery voltage, lies in the voltage range. Preferably, the voltage range is constant during the operation of the drive device, the two threshold values thus likewise remain constant. It is preferably provided that, when the battery voltage is in the voltage range, the connection of the traction battery is not changed and the number of battery modules remains the same. If the battery voltage falls below the first threshold value, the number of battery modules is adapted or changed, namely in such a way that the battery voltage increases.

The selection of the number of battery modules and the distribution of the cell modules between the battery modules are carried out in such a way that the battery voltage increases. In particular, the number of battery modules is selected such that the battery voltage is greater than the first threshold value, but smaller than the second threshold value. Ultimately, the change in the number of battery modules consequently leads to the battery voltage again being in the voltage range. For example, the voltage range includes a voltage difference corresponding to at least 30%, at least 40% or at least 50% and/or at most 70%, at most 60% or at most 50% of the nominal voltage of the traction machine. The use of the voltage range allows a flexible selection of the number of battery modules and the achievement of a sufficient voltage for operating the traction machine.

A further development of the invention provides that, in order to adapt the number of battery modules, among the plurality of connections of the battery modules, a connection is selected and set on the traction battery, wherein in a first of the connections the number of battery modules corresponds to a first battery module number and the number of cell modules per battery module corresponds to a first cell module number and in a second of the connections the number of battery modules corresponds to a second battery module number different from the first battery module number and the number of cell modules per battery module corresponds to a second cell module number different from the first cell module number.

The connections correspond to different electrical connections of the battery modules between the connections of the traction battery and correspondingly also to different numbers of the battery modules. In the first connection, the battery modules are present in the first number of battery modules and the cell modules are present in the first number of cell modules per battery module, in the second connection with the second number of battery modules and the second number of cell modules per battery module. From this, a total number of the cell modules always remains the same, so that the product of the first battery module number and the first cell module number corresponds to the product of the second battery module number and the second cell module number. Due to the different numbers of battery modules, different voltages are achieved between the connections at a given charge level.

A further development of the invention provides that a third connection is used as one of the connections, at which the number of battery modules corresponds to a third battery module number and the number of cell modules per battery module corresponds to a third cell module number, wherein the third battery module number differs both from the first battery module number and the second module number and the third cell module number differs both from the first cell module number and the second cell module number. Thus, at least three different connections are present, from which the connection is selected and set at the traction battery. Consequently, the traction battery is operated at times with the first connection, at times with the second connection and at times with the third connection. This results in a particularly high degree of flexibility and a reliable achievement of the desired battery voltage.

A further development of the invention provides that the number of battery modules is determined as a function of a charge level of the traction battery and/or a discharge current of the traction battery. It has already been stated that the voltage between the connections depends in particular on the charge level. In addition, however, there may also be a dependence on the discharge current. In particular, the higher the discharge current with which the traction battery is discharged for operating the traction machine, the lower the voltage. Determining the number of battery modules as a function of the charge level and/or the discharge current ensures to this extent that the electrical voltage applied to the connections corresponds at least to the operating voltage of the traction machine.

A further development of the invention provides that the first connection is selected as a connection when the charge level is in a first charge level range and the second connection is selected as a connection when the charge level is in a second charge level range adjacent to the first charge level range, wherein the electrical voltage in the first connection and at a charge level corresponding to a range limit of the first charge level range facing the second charge level range and the electrical voltage in the second connection and at a charge level corresponding to a range limit of the first charge level range facing the first charge level range are at a ratio to one another which corresponds to a ratio of the first battery module number and the second battery module number.

The two charge level ranges, that is to say the first charge level range and the second charge level range, adjoin one another directly, so that the (first) range limit of the first charge level range facing the second charge level range lies directly adjacent to the (second) range limit of the second charge level range, which limits it on its side facing the first charge level range. If the charge level is present in the first charge level range, the first connection is used and if the charge level is present in the second charge level range, the second connection is used.

A first battery voltage is present at a charge level corresponding to the first range limit and a second battery voltage is present at a charge level corresponding to the second range limit. The two connections are selected in such a way that the first voltage and the second voltage are present in a ratio to one another which corresponds to the ratio of the first battery module number and the second battery module number. In this respect, the connections do not result in a significant jump in the voltage applied to the connections, but the voltage is provided in accordance with the described rule. This ensures a reliable operation of the drive device.

According to a further development of the invention, the number of battery modules is selected at least temporarily in such a way that the electrical voltage applied to the connections is greater than a nominal voltage of the traction machine, and the inverter is controlled in such a way that an output voltage of the inverter corresponds at most to the nominal voltage. This means that the battery voltage provided by the traction battery, which represents an input voltage of the inverter, is reduced at least temporarily using the inverter, namely at least up to the nominal voltage of the traction machine.

For example, it is provided that the number of battery modules is selected at least temporarily in such a way that the battery voltage is at least 30%, at least 40% or at least 50% greater than the nominal voltage. The number of battery modules in different connections is preferably selected such that the battery voltage is greater than the nominal voltage, in particular by one of the stated percentages. With the aid of the inverter, however, operation of the traction machine is reliably implemented within its specification, so that the voltages resulting from the different interconnections of the cell modules ensure a sufficiently high drive power regardless of the charge level of the traction battery.

The invention also relates to a drive device for a motor vehicle, in particular for performing the method according to the explanations in the context of the present description, wherein the drive device has a traction battery having a plurality of cell modules and a drive unit which is designed as an electric traction machine and is electrically connected to electrical connections of the traction battery via an inverter, wherein the cell modules can be electrically connected in different ways between the connections.

The drive device is provided and configured such that the cell modules are divided up into battery modules which each contain the same number of electrically parallel-connected cell modules and are electrically connected in series between the connections, wherein a number of the battery modules is adapted during operation of the drive device in such a way that an electrical voltage applied to the connections corresponds to at least one operating voltage of the traction machine.

The advantages of such a procedure or configuration of the drive device have already been discussed. Both the drive device for a motor vehicle and the method for operating said drive device can be further refined according to the embodiments in the scope of this description, to which reference will therefore be made.

In addition, the invention relates to a computer program product comprising commands which cause the drive device according to the present description to carry out the method explained. Regarding the advantages and possible advantageous further developments, reference should be made to the description as a whole.

The features and feature combinations described in the description, in particular the features and feature combinations described below in the description of the FIGURES and/or shown in the FIGURES may be used not only in the respective combination specified, but also in other combinations or alone, without departing from the scope of the invention. The invention should therefore also be considered to comprise embodiments that are explicitly not shown or explained in the description and/or the FIGURES, but emerge from the explained embodiments or can be derived from them.

### BRIEF DESCRIPTION OF THE FIGURE(S)

In the following, the invention will be explained with reference to the exemplary embodiments depicted in the drawings, without this limiting the invention. In particular, the only

FIG. 1 is a schematic representation of a region of a drive device for a motor vehicle, namely a traction battery, for three different connections of cell modules.

### DETAILED DESCRIPTION

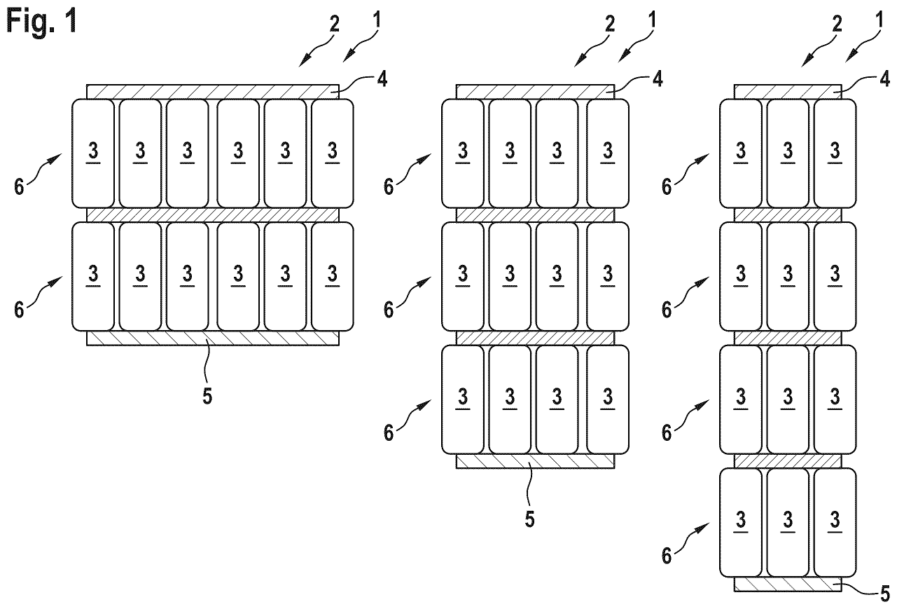

FIG. 1 shows a very schematic representation of a traction battery 1 which is a component of a drive device 2 of a motor vehicle. The traction battery 1 is shown here with three different connections of cell modules 3, namely on the far left with a first connection, in the middle with a second connection and on the far right with a third connection. Also shown only extremely schematically are electrical connections 4 and 5 of the traction battery, between which an electrical voltage is provided with the aid of the cell modules 3.

The cell modules are divided up into battery modules 6, two battery modules being present purely by way of example in the first connection, three battery modules 6 in the second connection and four battery modules 6 in the third connection. By way of example, a total of twelve cell modules 3 are shown, which are all always divided up between the battery modules 6, namely in such a way that each battery module 6 has the same number of cell modules 3. The cell modules 3 of each battery module 6 are electrically connected in parallel therein. The battery modules 6, on the other hand, are electrically connected in series between the connections 4 and 5. Correspondingly, with a constant voltage of the cell modules 3, different battery voltages of the traction battery 1 result between the connections 4 and 5.

The different connections are used at different charge levels of the traction battery in order to achieve a battery voltage which is sufficient to apply a sufficiently high operating voltage to a traction machine of the drive device 2 despite the different charge levels and the resulting different voltages of the cell modules 3. Overall, the procedure merely outlined here ensures that, despite different charge levels, similar voltages are always available for operating the traction machine.

### LIST OF REFERENCE NUMERALS

1 traction battery
2 drive device
3 cell module
4 connection
5 connection
6 battery module

1. A method for operating a drive device for a motor vehicle, wherein the drive device has a traction battery having a plurality of cell modules and a drive unit which is designed as an electric traction machine and is electrically connected via an inverter to electrical connections of the traction battery, wherein the cell modules can be electrically connected in different ways between the connections, wherein the cell modules are divided up into battery modules which in each case contain the same number of electrically parallel-connected cell modules and are electrically connected in series between the connections, wherein a number of the battery modules is adapted during operation of the drive device in such a way that an electrical voltage applied to the connections corresponds to at least an operating voltage of the traction machine.

2. The method according to claim 1, wherein the number of battery modules is selected such that the electrical voltage applied to the connections lies within a voltage range which contains the operating voltage, wherein the voltage range is limited by a first threshold value in the direction of lower voltages and by a second threshold value in the direction of higher voltages.

3. The method according to claim 1, wherein in order to adapt the number of battery modules, among the plurality of connections of the battery modules, a connection is selected and set on the traction battery, wherein in a first of the connections the number of battery modules corresponds to a first battery module number and the number of cell modules per battery module corresponds to a first cell module number and in a second of the connections the number of battery modules corresponds to a second battery module number different from the first battery module number and the number of cell modules per battery module corresponds to a second cell module number different from the first cell module number.

4. The method according to claim 1, wherein a third connection is used as one of the connections, at which the number of battery modules corresponds to a third battery module number and the number of cell modules per battery module corresponds to a third cell module number, wherein the third battery module number differs both from the first battery module number and the second battery module number and the third cell module number differs both from the first cell module number and the second cell module number.

5. The method according to claim 1, wherein the number of battery modules is determined as a function of a charge level of the traction battery and/or a discharge current of the traction battery.

6. The method according to any claim 1, wherein the first connection is selected as a connection when the charge level is in a first charge level range and the second connection is selected as a connection when the charge level is in a second charge level range adjacent to the first charge level range, wherein the electrical voltage in the first connection and at a charge level corresponding to a range limit of the first charge level range facing the second charge level range and the electrical voltage in the second connection and at a charge level corresponding to a range limit of the second charge level range facing the first charge level range are at a ratio to one another which corresponds to a ratio of the first battery module number and the second battery module number.

7. The method according to claim 1, wherein the number of battery modules is selected at least temporarily in such a way that the electrical voltage applied to the connections is greater than a nominal voltage of the traction machine, and the inverter is controlled in such a way that an output voltage of the inverter corresponds at most to the nominal voltage.

8. The method according to claim 1, wherein a sodium-ion battery is used as the traction battery.

9. A drive device for a motor vehicle, comprising: a traction battery having a plurality of cell modules and a drive unit which is designed as an electric traction machine and is electrically connected via an inverter to electrical connections of the traction battery, wherein the cell modules can be electrically connected in different ways between the connections, wherein the drive device is configured to divide the cell modules into battery modules which in each case contain the same number of electrically parallel-connected cell modules and are electrically connected in series between the connections, wherein a number of the battery modules is adapted during operation of the drive device in such a way that an electrical voltage applied to the connections corresponds to at least an operating voltage of the traction machine.

10. A computer program product comprising instructions for a drive device to carry out the method according to claim 1.

11. The method according to claim 2, wherein in order to adapt the number of battery modules, among the plurality of connections of the battery modules, a connection is selected and set on the traction battery, wherein in a first of the connections the number of battery modules corresponds to a first battery module number and the number of cell modules per battery module corresponds to a first cell module number and in a second of the connections the number of battery modules corresponds to a second battery module number different from the first battery module number and the number of cell modules per battery module corresponds to a second cell module number different from the first cell module number.

12. The method according to claim 2, wherein a third connection is used as one of the connections, at which the number of battery modules corresponds to a third battery module number and the number of cell modules per battery module corresponds to a third cell module number, wherein the third battery module number differs both from the first battery module number and the second battery module number and the third cell module number differs both from the first cell module number and the second cell module number.

13. The method according to claim 3, wherein a third connection is used as one of the connections, at which the number of battery modules corresponds to a third battery module number and the number of cell modules per battery module corresponds to a third cell module number, wherein the third battery module number differs both from the first battery module number and the second battery module number and the third cell module number differs both from the first cell module number and the second cell module number.

14. The method according to claim 2, wherein the number of battery modules is determined as a function of a charge level of the traction battery and/or a discharge current of the traction battery.

15. The method according to claim 3, wherein the number of battery modules is determined as a function of a charge level of the traction battery and/or a discharge current of the traction battery.

16. The method according to claim 4, wherein the number of battery modules is determined as a function of a charge level of the traction battery and/or a discharge current of the traction battery.

17. The method according to any claim 2, wherein the first connection is selected as a connection when the charge level is in a first charge level range and the second connection is selected as a connection when the charge level is in a second charge level range adjacent to the first charge level range, wherein the electrical voltage in the first connection and at a charge level corresponding to a range limit of the first charge level range facing the second charge level range and the electrical voltage in the second connection and at a charge level corresponding to a range limit of the second charge level range facing the first charge level range are at a ratio to one another which corresponds to a ratio of the first battery module number and the second battery module number.

18. The method according to any claim 3, wherein the first connection is selected as a connection when the charge level is in a first charge level range and the second connection is selected as a connection when the charge level is in a second charge level range adjacent to the first charge level range, wherein the electrical voltage in the first connection and at a charge level corresponding to a range limit of the first charge level range facing the second charge level range and the electrical voltage in the second connection and at a charge level corresponding to a range limit of the second charge level range facing the first charge level range are at a ratio to one another which corresponds to a ratio of the first battery module number and the second battery module number.

19. The method according to any claim 4, wherein the first connection is selected as a connection when the charge level is in a first charge level range and the second connection is selected as a connection when the charge level is in a second charge level range adjacent to the first charge level range, wherein the electrical voltage in the first connection and at a charge level corresponding to a range limit of the first charge level range facing the second charge level range and the electrical voltage in the second connection and at a charge level corresponding to a range limit of the second charge level range facing the first charge level range are at a ratio to one another which corresponds to a ratio of the first battery module number and the second battery module number.

20. The method according to any claim 5, wherein the first connection is selected as a connection when the charge level is in a first charge level range and the second connection is selected as a connection when the charge level is in a second charge level range adjacent to the first charge level range, wherein the electrical voltage in the first connection and at a charge level corresponding to a range limit of the first charge level range facing the second charge level range and the electrical voltage in the second connection and at a charge level corresponding to a range limit of the second charge level range facing the first charge level range are at a ratio to one another which corresponds to a ratio of the first battery module number and the second battery module number.
